(19) United States
(12) Patent Application Publication
(10) Pub. No.: US 2003/0009334 A1
(43) Pub. Date: Jan. 9, 2003

(54) Speech processing board for high volume speech processing applications

(75) Inventors: Harry W. Printz, San Francisco, CA (US); Bruce A. Smith, Austin, TX (US)

Correspondence Address: Gregory A. Nelson, Akerman Senterfltt, 222 Lakeview Avenue, Fourth Floor, P.O. Box 3188, West Plam Beach, FL, 33402-3188, US

(73) Assignee: International Business Machines Corporation, Armonk, NY

(21) Appl. No.: 09/898,282

(22) Filed: Jul. 3, 2001

(51) Int. Cl. G10L 15/14

(52) U.S. Cl. 704/256

(57) ABSTRACT

A speech processing board configured in accordance with the inventive arrangements can include multiple processor modules, each processor module having an associated local memory, each processor module hosting at least one instance of a speech application task; a storage system for storing speech task data, the speech task data including language models and finite state grammars; a local communications bus communicatively linking each processor module through which each processor module can exchange speech task data with the storage system; and, a communications bridge to a host system, wherein the communications bridge can provide an interface to the local communications bus through which data can be exchanged between the processor modules and the host system. Notably, the host system can be a CT media services system or a VoIP gateway/endpoint.

### BACKGROUND OF THE INVENTION

1. Technical Field

The present invention relates to speech recognition and more particularly to a speech processing board.

2. State of the Art

Present modes of communication are rapidly changing due to the integration of the computer and telephone. Computer Telephony (CT) represents this integration and includes the utilization both of speech recognition technology and text-to-speech (TTS) technology. Companies such as International Business Machines Corporation have implemented telephone speech recognition platforms capable both of continuous speech recognition and TTS playback. As a result, CT has become one of the fastest growing applications markets for speech recognition, with many companies producing products specifically for the CT market.

For instance, Dialogic Corporation of Parsippany, N.J. USA has developed a speech processing board for use in CT. Specifically, the Dialogic speech processing board is a CT solution which conforms to the compact PCI (cPCI) communications specification. The speech processing board can include an open architecture which can accommodate the integration of CT related resources such as a automatic speech recognition, TTS playback and call control. The architecture further can include a high-level application programming interface (API) based on the well-known Enterprise Computer Telephony Forum (ECTF) API. The Dialogic speech processing board can include a CT Bus for facilitating the integration of the speech processing board with a CT system. The CT Bus in the Dialogic speech processing board is a time division multiplexing (TDM) bus that provides 1024, 2048, or 4096 time slots for exchanging voice, fax, or other network resources on the cPCI backplane. Notably, the CT Bus conforms to the H.110 standard which allows CT application developers to build large, distributed, open CT systems in public network and customer premises environments.

By comparison, Lucent Technologies, Inc. of Murray Hill, N.J. USA also manufactures a cPCI compliant speech processing board for use in CT applications. Lucent's speech processing board enables service providers to provide customers with speech-enabled applications in the CT environment. Like the Dialogic speech processing board, the Lucent speech processing board can support more than one hundred audio channels. Moreover, the speech processing board can support multiple speech applications such as speech recognition and TTS playback. Notably, the Lucent speech processing board can provide flexible speech recognition capabilities ranging from simple connected digits to complex grammar-based, continuous speech. Finally, like the Dialogic speech processing board, the Lucent speech processing board meets the ECTF cPCI standards, including the industry-standard H.110 interface.

Still, as the volume of speech processing applications increases in a CT system, both the Dialogic and Lucent speech processing boards are unable to adequately process each speech processing task using one speech processing board alone. In consequence, both Dialogic Corporation and Lucent Technologies, Inc. suggest the use of multiple speech processing boards to handle high volume speech applications. The use of multiple speech processing boards, however, can consume valuable bus slots and can increase the number of hardware resources necessary to accommodate each speech processing board. Hence, what is needed is a speech processing board which is optimized for high volume speech processing applications.

### SUMMARY OF THE INVENTION

The speech processing board of the present invention is an optimized speech processing board for use in high volume speech processing applications. The speech processing board can include multiple processors, each which can execute multiple instances of speech applications for performing both large and small vocabulary recognition tasks. The speech processing board design and associated firmware can work in concert to provide state-of-the-art speech recognition capabilities for deployment in classical computer telephony (CT) applications or in gateways/endpoints of voice over IP (VoIP) applications. The speech processing board also can accommodate multiple instances of Text-to-Speech (TTS) applications. Finally, the speech processing board can support various levels of session control applications such as dialog manager natural language understanding (NLU) engines and traditional interactive voice response (IVR) applications.

A speech processing board configured in accordance with the inventive arrangements can include multiple processor modules, each processor module having an associated local memory, each processor module hosting at least one instance of a speech application task; a storage system for storing speech task data, the speech task data including language models and finite state grammars; a local communications bus communicatively linking each processor module through which each processor module can exchange speech task data with the storage system; and, a communications bridge to a host system, wherein the communications bridge can provide an interface to the local communications bus through which data can be exchanged between the processor modules and the host system. Notably, the host system can be a CT media services system or a VoIP gateway/endpoint.

Each processor module can include a central processing unit (CPU) core having at least one memory cache which can be accessed by the CPU core; a processor bridge communicatively linking the CPU core to the local communications bus; and, a memory controller through which the CPU core can access the local memory, wherein the memory controller can be linked to the CPU core through a processor local bus. Additionally, a language model cache can be disposed in the local memory. Finally, a finite state grammar table can be disposed in the local memory.

The storage system can include a fixed storage device accessible by the processor modules through the communications bridge, wherein the fixed storage device stores active language models and finite state grammars used by the speech application tasks hosted by the processor modules; a commonly addressed language model cache, wherein the language model cache can store at least one image of a language model stored in the fixed storage device, each processor module accessing the language model cache through the communications bridge at a common address; and, a boot memory storing initialization code, wherein the boot memory is communicatively linked to the processor modules through the communications bridge, each processor module accessing the boot memory during an initial power-on sequence.

The local communications bus can be a PCI bus. More particularly, the PCI bus can be a 64-bit, 133 MHz PCI bus. Alternatively, the PCI bus can be a 64-bit, 66 MHz PCI bus. The communications bridge can include a PCI-to-PCI bridge having a PCI interface to the host system and an interface to an H.1×0 bus. The communications bridge also can include a processing element for managing message communications between the speech processing board and the host system according to a messaging protocol provided by the host system. Notably, the communications bridge can be implemented in a field programmable gate array (FPGA).

The speech processing board also can include a serial audio channel communicatively linking the processor modules to the communications bridge. The serial audio channel can provide a medium upon which audio data can be exchanged between individual processor modules and the communications bridge. An audio stream processor also can be provided which can be coupled to the communications bridge. The audio stream processor can be configured to extract audio information received in the communications bridge, store the extracted audio information and distribute the audio information over the serial audio channel to selected ones of the processor modules based on hosted instances of speech applications in each processor module.

In one particular embodiment of the present invention, a speech processing board can include multiple processor modules in the speech processing board; a PCI-to-PCI bridge interfacing the local PCI interface to a host CT system, a local PCI interface linking each processor module to the PCI-to-PCI bridge; a fixed storage communicatively linked to the PCI-to-PCI bridge and accessible by the processor modules through a drive controller; a language model cache communicatively linked to the bridge; and, a boot memory communicatively linked to the bridge, the boot memory storing initialization code. Notably, the PCI-to-PCI bridge can include interfaces to an H.1×0 bus and a PCI bus.

A high-volume speech processing method in accordance with the inventive arrangements can include the steps of loading and executing a plurality of speech application tasks in selected ones of multiple processor modules in a speech processing board; loading in a commonly addressed storage separate from the multiple processor modules, selected language models for use by the speech application tasks; receiving audio data over an audio channel and distributing the audio data to particular ones of the processor modules, wherein the distribution of the audio data to particular ones of the processor modules is determined based upon speech application tasks executing in the particular ones of the processor modules; processing the received audio data in the particular ones of the processor modules using the language models selected for use by the speech application tasks; and, caching in the selected ones of the multiple processor modules portions of the selected language models used by the speech application tasks. The method also can include the steps of collecting speech task results from the selected ones of the multiple processor modules; and, forwarding the collected speech task results to a host CT system over a host communications bus.

### BRIEF DESCRIPTION OF THE DRAWINGS

There are shown in the drawings embodiments which are presently preferred, it being understood, however, that the invention is not limited to the precise arrangements and instrumentalities shown, wherein:

FIG. 1 is a block diagram illustrating a speech processing board configured in accordance with the inventive arrangements.

FIG. 2 is a block diagram of a processing module for use in the speech processing board of FIG. 1.

FIG. 3 is a schematic illustration of the speech processing board of FIG. 1 integrated with an ECTF-compliant computer telephony system.

### DETAILED DESCRIPTION OF THE INVENTION

I. Overview

The present invention is a speech processing board which has been optimized for use in high volume speech processing applications. Unlike conventional speech processing boards, the speech processing board of the present invention can include multiple processor modules each of which can execute multiple instances of full function, large vocabulary speech recognition tasks similar to those of a conventional speech recognition engine with shared memory. The speech processing board can be deployed both in a conventional computer telephony (CT) architecture and in a voice over IP (VoIP) gateway/endpoint architecture. The speech processing board of the present invention also can accommodate multiple instances of text-to-speech (TTS) application tasks and small vocabulary speech recognition tasks.

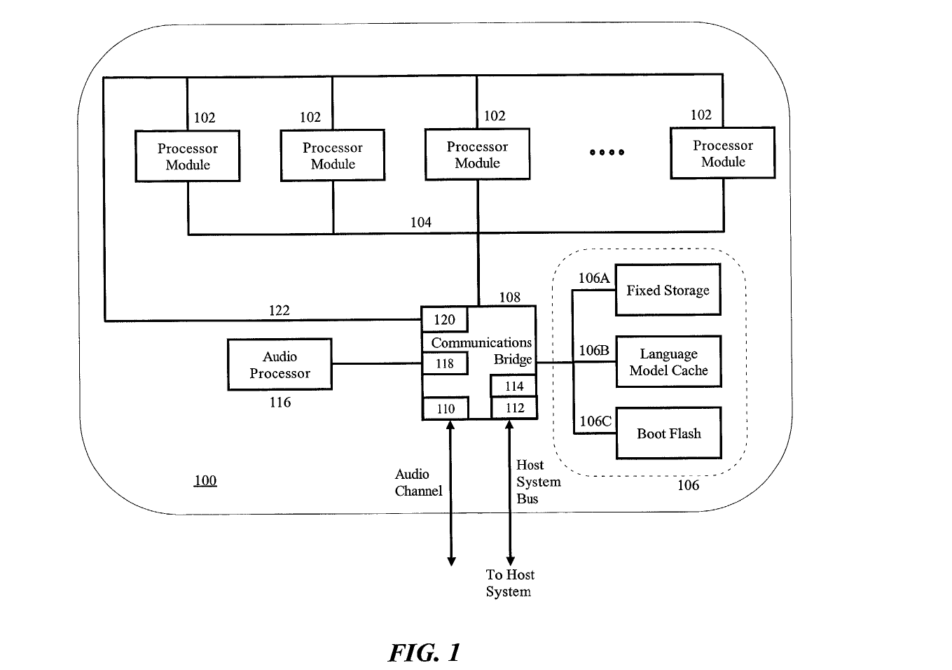

FIG. 1 is a block diagram illustrating a speech processing board 100 configured for use in high volume speech processing applications according to the inventive arrangements. The speech processing board can include multiple processor modules 102, a local communications bus 104, a storage system 106 and a communications bridge 108. Each processor module can have an associated local memory and can host therein one or more instances of selected speech application tasks. Speech application tasks can include both large and small vocabulary speech recognition tasks, speech synthesis (TTS) tasks, natural language processing and the like. Each processor module 102 further can be communicatively linked with the local communications bus 104.

Processor modules 102 can exchange speech task data with the storage system 106 through the local communications bus 104. In one aspect of the present invention, the storage system 106 can include fixed storage 106A, a language model cache 106B and boot memory 106C. The fixed storage 106A can be a compact fixed disk drive analogous to a hard disk drive. The Microdrive® manufactured by International Business Machines Corporation of Armonk, N.Y. USA is an example of compact fixed storage. The fixed storage 106A can store active language models and finite state grammars used by the speech application tasks in the processor modules 102. The processor modules 102 can access the fixed storage 106A through a disk controller such an IDE or ATA compatible interface which is linked to the communications bridge 108.

By comparison, the language model cache 106B can be volatile or non-volatile memory such and can store at least one image of a language model stored in the fixed storage. As in the case of the fixed storage 106A, each processor module 102 can access the language model cache 106B through the communications bridge 108. Notably, the language model cache 106B can be accessed by each processor module 102 at a common address. Finally, the boot memory 106C can be a non-volatile memory such as a ROM or flash memory. The boot memory 106C can store initialization code and, like the fixed storage 106A and language model cache 106B, the boot memory 106C can be communicatively linked to the processor modules 102 through the communications bridge 108. The boot memory 106C can be predominantly used during an initial power-on sequence at which time initialization code can be provided to the processor modules 102.

The communications bridge 108 can be an adapter to a host system such as a computer telephony (CT) system or VoIP gateway/endpoint. The communications bridge 108 can provide an interface to the local communications bus 104 through which data can be exchanged between the processor modules 102 and the host system. Where the host system is a VoIP gateway/endpoint, an Ethernet switch (not shown) can be included which can process incoming and outgoing audio packets which conform to the VoIP protocol. In contrast, where the host system is a CT system, audio data can be received through a PCI interface.

In particular, where the local communications bus is a PCI bus and the host system provides a PCI interface, the communications bridge 108 can be a PCI-to-PCI bridge. Furthermore, where the host system is a CT system compliant with the Enterprise Computer Telephony Forum (ECTF) system architecture, the communications bridge 108 can be a PCI-to-PCI bridge having a PCI host interface 112 to the CT system and an audio interface 110 to an H.1×0 bus. In particular, where the speech processing board 100 includes a conventional PCI design, the audio interface 110 can be an interface to an H.100 bus. In contrast, where the speech processing board 100 includes a compact PCI (cPCI) design, the audio interface 110 can be an interface to an H.110 bus.

The communications bridge 108 also can include a processing element 114 for managing message communications between the speech processing board 100 and the host system according to a messaging protocol provided by the host system. 12. Finally, the speech processing board 100 can include an audio stream processor 116 coupled to the communications bridge 108. The audio stream processor 116 can manage incoming audio data arriving from either the audio interface 110 or the PCI interface 112. The audio stream processor 116 can be a programmable digital signal processor (DSP) and can be programmatically configured to extract audio data received in the communications bridge 108. Once extracted the audio information can be temporarily stored in local memory 118 before being distributed over a serial audio channels 122 to selected processor modules 102 by a local audio controller 120 based on hosted instances of speech application tasks in each processor module 102 as described by host system's messaging protocols.

II. Speech Processing Board Detail

The speech processing board 100 of the present invention can be logically viewed as having several subsystems including a communications subsystem (commands and data), a communications bridge, a processing subsystem, and a memory subsystem. In general, however, the speech processing board 100 has a basic method of operation which involves the execution of multiple instances of speech application task images such as speech recognition or TTS playback.

### Communications Subsystem

In a preferred aspect of the present invention, the communications subsystem can include a PCI design that can be implemented in either standard PCI format or in cPCI format. The primary communications channel, PCI, is utilized by the communications bridge 108 to communicate specific commands and result sets stemming from those commands to and from the processor modules 102, to upload language models and finite state grammars to the storage system 106, and to upload firmware updates to the processor modules 102. Also, as will be apparent to one skilled in the art, audio data can be transferred to the speech processing board 100 both via the system PCI bus interface 112 and the audio interface 110.

By comparison, the local communications bus 104 can provide a communications path between processor modules 102. Additionally, the local communications bus 104 can serve as the communications medium between large vocabulary recognition tasks and corresponding language models. Notably, in one aspect of the present invention, the language models for use by speech recognition tasks in the speech processor board 100 generally can be stored in one of three system resources: the local memory of the processor modules 102, the local memory 118 of the communications bridge 108, or the fixed storage 106A.

Importantly, to minimize the response time of a speech recognition task, it can be helpful for the processor modules 102 to be able to access language models stored in the speech processor board 100 in as close to real-time as possible. For this reason, it is preferable that a local communications bus 104 is selected to be wider and faster than a corresponding host system bus. For example, one satisfactory configuration can include a local communications bus 104 which is a 64 bit wide 133 MHz PCI bus. This configuration yields a burst data rate which exceeds 1 GB/s in throughput. Still, to facilitate the use of field programmable gate arrays (FPGAs) in the speech processor board 100, the local communications bus can be limited to a 64 bit wide 66 MHz PCI bus yielding a maximum burst data rate of 528 MB/sec.

### Communications Bridge

In one aspect of the invention, the communications bridge 108 can be PCI-to-PCI bridge and can be included in a programmable logic block for instance an FPGA. The communications bridge 108 can include an audio interface 110 which can be configured to receive audio data from an H.1×0 bus. In particular, the audio interface 110 can be a bus end-point which is compliant with the ETCF hardware specifications H.100 (PCI) or H.110 (cPCI). Notably, the H.1×0 bus endpoint can be contained in a programmable logic block within the PCI-to-PCI bridge. Local memory 118 attached to the communications bridge 108 can serve as a communications buffer for audio data.

The programmable logic of the communications bridge 108 also can include a local audio controller 120 for local audio distribution. Specifically, audio data can be distributed over serial audio channels 122 which link the communications bridge 108 to the processor modules. The serial audio channels can be configured to communicate using conventional UARTs or 12C technology. Notably, recent revisions to the 12C interface can support 3.4 Mbps data streams.

Run-time commands and result sets can be passed through the host interface 112 between the speech processing board 100 and the host system. Typical runtime commands can include requests for the speech processing board 100 to perform an operation on a specific audio stream received through the audio interface 110 followed by command status responses, speech application task results and the like. For example, where a requested operation is a speech recognition task, the speech processing board 100 can report recognition results to the host system through the communications bridge 108. Optionally, the result sets can include associated probabilities.

In a preferred aspect of the invention, the communications bridge 108 includes the audio interface 110 through which audio streams can be communicated between the speech processing board 100 and the host system. Notwithstanding, where a host system does not support the H.1×0 bus, audio stream data can be provided through the host interface 112. In that case, the communications bridge 108 can detect the receipt of audio data and can route the audio data to an on-board audio communications function which can pre-process the audio data. Once pre-processed, the audio data can be routed to individual processing modules 102 as would be the case were the audio data received through the audio interface 110.

### Processor Subsystem

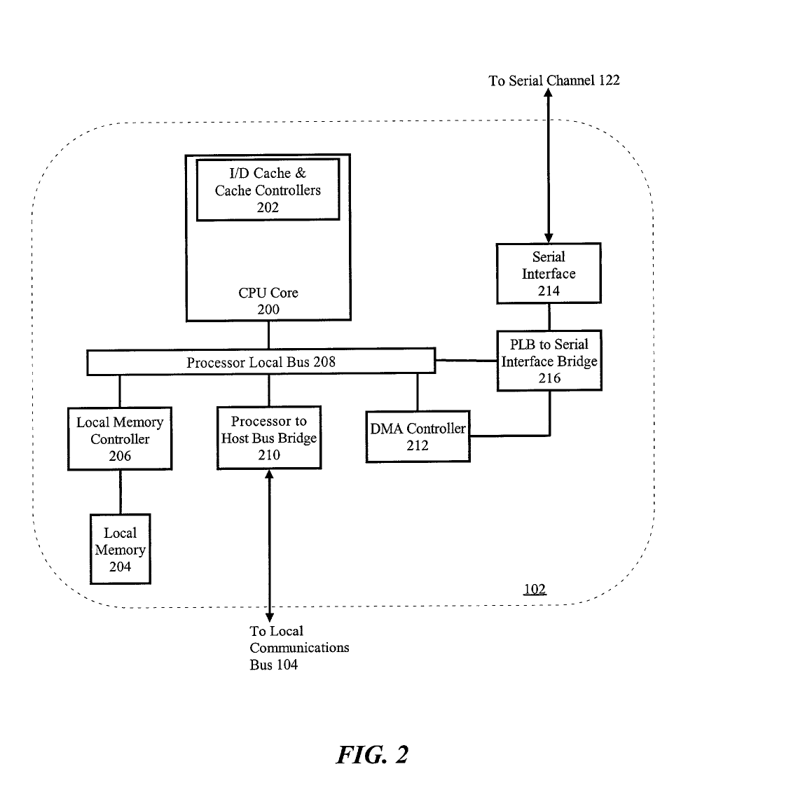

FIG. 2 is a block diagram of a processing module 102 for use in the speech processing board 100 of FIG. 1. Specifically, the speech processing board 100 can be configured either with commercial off-the shelf (COTS) processor modules, or processor modules specifically designed for performing speech processing tasks. In either case, each processor module 102 can include basic elements such as a CPU core 200 with on-board cache 202, local memory 204, local memory controller 206 and a processor local bus (PLB) 208 communicatively linking the core 200 with the controller 206. For instance, an exemplary processor module 102 can include a 555 MHz PowerPC core with 32K/32K instruction and data (I/D) caches, a 133 MHz Processor Local Bus, 8 KB of PLB-attached Static RAM (SRAM) and external SDRAM controllable by the core through a 64-bit PC-133/PC-266 Double Data Rate (DDR) SDRAM Controller.

The processor local bus 208 also can link the core 200 to an external communications bus such as the local communications bus 104 through a communications bridge 210 such as a PowerPC-to-PCI Interface Bridge. Notably, the processor module 102 can include on-chip ethernet channels. In consequence, the processor module 102 can be configured to directly transmit and receive audio packets from a VoIP gateway/endpoint over a packet-switched network.

As in the case of conventional processor modules, the processor module 102 of the present invention can include a DMA controller 212 such as a 4 Channel DMA Controller. Finally, the processor module 102 can include a serial interface 214, for example a vl.0 USB Controller and a 3.4 Mbps 12C interface, each accessible across the PLB 208 through a PLB to serial interface bridge 216. Notably, the entire processor module 102 can be housed in a 404 I/O, 575 pin BGA package occupying approximately one square inch of board area on the speech processor board 100.

### Memory Subsystem

The memory subsystem can be subdivided into a memory locally available in each processor module 102, and remote memory commonly available to each processor module 102. Locally, each processor module 102 can have various types of memory available for use by loaded speech application tasks including L1 I/D caches, on chip SRAM, and local high performance SRAM. Likewise, each processor module 102 can access remote SDRAM-based language model caches and remote bootstrap memory in non-volatile memory such as flash memory. The extended L1 cache sizes can be 32 KB. The on chip SRAM can be relatively small (less than 16 KB) and can be used primarily as a buffer for audio data exchanged with the local SDRAM. An on chip L2 cache can be optionally provided.

Local memory 204 can be addressed by an on chip local memory controller 206 that connects to the on chip processor local bus 208. In the case where the local memory controller 206 is a DDR SDRAM controller, the local memory controller 206 can support 266 MHz DDR SDRAMs in 8 byte widths yielding burst data rates which exceed 2 GB/sec. Notably, the data rates supported by a DDR SDRAM controller are substantially higher than conventional desktop computer memory designs and approximates the data rates of on chip L2 cache. In consequence, though an L2 cache can be included in a processor module 102, it is not required.

The local memory subsystem can provide a repository for speech application task program code, data tables, acoustic models, language model cache, complete finite state grammars, and memory structures associated with speech processing software. In addition, the local memory subsystem can include a portion allocated to a control program, for instance a real-time operating system (RTOS) which can manage memory allocation, task switching and communications activities. Significantly, a substantial portion of the local memory 204 of each processor module 102 can be allocated as a language model cache in order to further reduce traffic in the local communications bus 104. Similarly, finite state grammar tables can be stored locally in the local memory 204 of each processor module 102 having a loaded speech application task based thereon.

Three types of remote memory are available for use by processor modules 102 which can include boot memory 106C, a language model cache 106B, and the fixed storage 106A, each accessible via the communications bridge 108. The boot memory 106C can be accessed by the processor modules 102 during an initial power-on sequence. Specifically, once power has been applied to the speech processing board 100 or a bus reset has been detected, the communications bridge 108 can hold all of the processor modules 102 in a reset state. The reset can be deactivated to each processor module 102 which can issue a reset vector fetch directed to the boot memory 106C. The processor module then can load the RTOS and other initialization code into local memory 204, execute power-on diagnostics and enter an idle loop awaiting a command from the host system.

The language model cache 106B generally can include a complete image of one or more language models that are stored in the fixed storage 106A. Physically, the language model cache can be pluggable, volatile memory such as SDRAM configured in SO-DIMM packaging. In consequence, different memory configurations can be selected allowing for versions of the speech processing board 100 that are optimized for low cost, mainly small vocabulary tasks, or high performance NLU or large vocabulary tasks. Presently, the nominal SDRAM requirement for a single language large vocabulary can be 128 MB while 32 MB or less can suffice for systems utilizing sub-500 word, finite state grammar speech recognition tasks. Also, in the case where the local communications bus 104 is a 64 bit wide 133 MHz PCI bus, the SDRAM can be 8 bytes wide and operate at 133 MHz or 266 MHz.

Importantly, the language model cache 106B can be mapped to a common address space where the language model cache 106 can be uniformly accessed by all processor modules 102 in the speech processing board 100. Specifically, as part of the initialization sequence performed by the speech processor board 100, individual language models can be loaded into volatile memory, for example SDRAM, according to a pre-defined memory schema. Each language model can be stored contiguously in memory. During the boot strap load process performed by each processor module 102, a uniform starting address can be provided to the processor module 102. Notably, in a preferred aspect of the present invention, only a small portion of the SDRAM is mapped into the host system memory address space as required for host communications.

The final memory type available for use by the processor modules 102 is the fixed storage 106A. The fixed storage 106A can be a compact device such as a Microdrive which can be linked to the communications bridge 108 via a CompactFlash (CF) controller similar to a PCMCIA IDE interface. One suitable CF controller for use with a fixed storage device such as the Microdrive has been manufactured by International Business Machines Corporation of Armonk, N.Y. USA. The fixed storage 106A can store all active language models and finite state grammars in use by processor modules 102 in the speech processing board 100.

III. Integration of Speech Processing Board with ECTF Framework

The speech processing board 100 can provide speech processing services in one of several types of CT systems. To date CT systems have been generally proprietary implementations. Still, the Enterprise Computer Telephony Forum (ECTF) framework represents an effort to define a standard CT system architecture. The ECTF framework can reduce the complexity of integrating CT subsystems by defining general-purpose telephony components with fully specified interfaces to enable interoperability among different products from different vendors.

The ECTF framework references two types of servers. Application servers execute call control, administration, reporting, and media services applications in a distributed network. By comparison, CT servers provide the call control, administration, resource management functionality, network access, and media resources (lines, voice recognition, fax) required by the applications. Application servers and CT servers communicate in client-server relationships. By thoroughly specifying the interfaces between application servers, CT servers, and the hardware and software components of each server, the broadest range of interoperability can be achieved.

The ECTF has developed a comprehensive CT Framework which encompasses: Architecture, Modeling, Interfaces (Protocols and APIs) and ECTF Models. Often overlooked, models play an important role in a comprehensive framework of interoperability specifications. Models define the conceptual basis, terminology, and behaviors, and correct usage of interfaces. While interfaces define the syntax by which two components connect, models define the language.

The ECTF has defined the following models: C.001 Call Control Model, M.001 Administrative Services Model, S.100 Media Services Model, and R.100 Call Center Reporting Model. The ECTF also has defined the following interfaces: C.100 JTAPI Call Control, M.100 Administrative Services Interface, M.500 SNMP MIB Specification, S.100 Media and Switching Services Interface, S.200 Transport Protocol Interface, S.300 Service Provider Interface, S.410 JTAPI Media Interface, H.100 CT Bus for PCI, and the H.110 HCT Bus for Compact PCI.

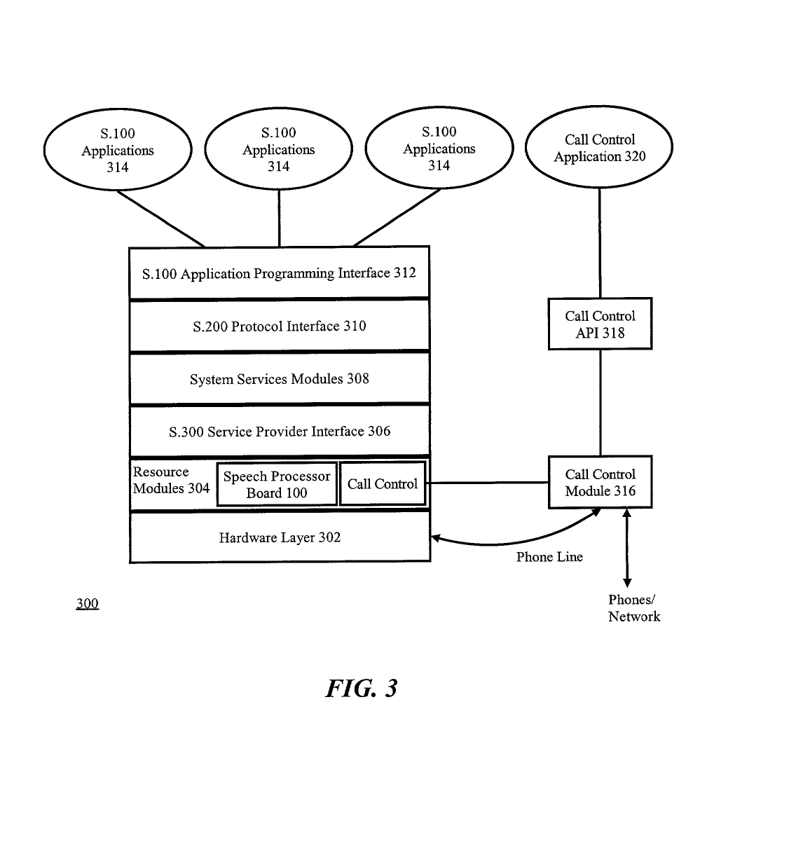

FIG. 3 illustrates a CT architecture based on an ECTF framework which incorporates the speech processing board 100 of the present invention. Specifically, FIG. 3 is a schematic illustration of the speech processing board 100 of FIG. 1 integrated with a generalized ECTF-compliant CT media services system 300. The media services system 300 can process CT media services applications to share media resources and integrate with existing call control architectures. Media services refers to the branch of CT technology that is concerned with media processing, including playing and recording of voice files, speech recognition and text-to-speech technology, DTMF detection and generation, and T.30 and T.611 fax services. Media services technology involves making media processing resources in a telephone system available to client software.

The media services system 300 can include a CT hardware layer 302, resource modules 304, a service provider interface 306 to system services modules 308, protocol interface 310, and an application programming interface 312 to CT applications 314. The media services system also can include a call control module 316 and a call control API 318 providing access to the call control module 316 for call control applications 320. Notably, the speech processing board 100 can integrate with the media services system 300 at the service provider interface 306.

In general the media services system 300 assumes that the speech functions are independent engines which receive audio streams and respond with speech recognized text. The routing of the audio stream. specification of related grammars and vocabularies are the responsibility of a call routing stack. This set of functions includes identifying the level of speech application support required to support the call which can be pre-defined based on a number called and the state of the call.

All grammars. vocabularies. acoustic and language models are assumed to be resident on the speech processing board 100 and pre-loaded into the language model cache 106B based on the defined set of speech application tasks. Additional copies of the various data sets for other inactive tasks, including different languages, generally can be resident on the fixed storage 106A. Task management tools accompanying the speech processing board 100 can assist users in defining grammars and conversational models. These tools can tag the appropriate data sets resident on the fixed storage 106A for loading into the language model cache 106BA as needed.

IV. Conclusion

The ECTF model provides a straightforward entry point for the speech processing board 100 in a CT environment since all of the call management software can be used generally except that some modifications may be necessary to recognize that multiple levels of speech application functionality can be supported. In this manner the speech processing board 100 can focus on execution of instances of speech application tasks, on board audio path management on a per task basis, and management of host messaging protocols.

The present invention can be realized in hardware, software, or a combination of hardware and software. Moreover, the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which when loaded in a computer system is able to carry out these methods. Computer program means or computer program in the present context means any expression, in any language, code or notation, of a set of instructions intended to cause a system having an information processing capability to perform a particular function either directly or after either or both of the following a) conversion to another language, code or notation; b) reproduction in a different material form.

Significantly, this invention can be embodied in other specific forms without departing from the spirit or essential attributes thereof, and accordingly, reference should be had to the following claims, rather than to the foregoing specification, as indicating the scope of the invention.

We claim:

1. A speech processing board comprising:
multiple processor modules, each said processor module having an associated local memory, each said processor module hosting at least one instance of a speech application task;
a storage system for storing speech task data, said speech task data comprising language models and finite state grammars;
a local communications bus communicatively linking each said processor module through which each said processor module can exchange speech task data with said storage system; and,
a communications bridge to a host system, said communications bridge providing an interface to said local communications bus through which data can be exchanged between said processor modules and said host system.

2. The speech processing board of claim 1, wherein each said processor module comprises:
a central processing unit (CPU) core having at least one memory cache which can be accessed by said CPU core;
a processor bridge communicatively linking said CPU core to said local communications bus; and,
a memory controller through which said CPU core can access said local memory, said memory controller linked to said CPU core through a processor local bus.

3. The speech processing board of claim 2, further comprising a language model cache disposed in said local memory.

4. The speech processing board of claim 2, further comprising a finite state grammar table disposed in said local memory.

5. The speech processing board of claim 1, wherein said storage system comprises:
a fixed storage device accessible by said processor modules through said communications bridge, wherein said fixed storage device stores active language models and finite state grammars used by said speech application tasks hosted by said processor modules;
a commonly addressed language model cache, said language model cache storing at least one image of a language model stored in said fixed storage device, each said processor module accessing said language model cache through said communications bridge at a common address; and,
a boot memory storing initialization code, said boot memory communicatively linked to said processor modules through said communications bridge, each said processor module accessing said boot memory during an initial power-on sequence.

6. The speech processing board of claim 1, wherein said local communications bus is a PCI bus.

7. The speech processing board of claim 6, wherein said PCI bus is a 64-bit, 133 MHz PCI bus.

8. The speech processing board of claim 6, wherein said PCI bus is a 64-bit, 66 MHz PCI bus.

9. The speech processing board of claim 1, wherein said communications bridge comprises a PCI-to-PCI bridge having a PCI interface to said host system and an interface to an H.1×0 bus.

10. The speech processing board of claim 9, wherein said communications bridge further comprises a processing element for managing message communications between the speech processing board and said host system according to a messaging protocol provided by said host system.

11. The speech processing board of claim 1, wherein said communications bridge is implemented in a field programmable gate array (FPGA).

12. The speech processing board of claim 1, further comprising a serial audio channel communicatively linking said processor modules to said communications bridge, said serial audio channel providing a medium upon which audio data can be exchanged between individual processor modules and said communications bridge.

13. The speech processing board of claim 12, further comprising an audio stream processor coupled to said communications bridge, said audio stream processor configured to extract audio information received in said communications bridge, store said extracted audio information and distribute said audio information over said serial audio channel to selected ones of said processor modules based on hosted instances of speech applications in each said processor module.

14. The speech processing board of claim 12, further comprising an ethernet switch coupled to said communications bridge, said ethernet switch configured to transmit and receive packetized audio information to and from an external network.

15. The speech processing board of claim 1, wherein said host system is a CT media services system.

16. The speech processing board of claim 1, wherein said host system is a voice over IP (VoIP) gateway/endpoint.

17. A speech processing board comprising:
multiple processor modules in the speech processing board;
a PCI-to-PCI bridge interfacing said local PCI interface to a host CT system, said bridge comprising interfaces to an H.1×0 bus and a PCI bus;
a local PCI interface linking each said processor module to said PCI-to-PCI bridge;
a fixed storage communicatively linked to said PCI-to-PCI bridge and accessible by said processor modules through a drive controller;
a language model cache communicatively linked to said bridge; and,
a boot memory communicatively linked to said bridge, said boot memory storing initialization code.

18. A high-volume speech processing method comprising the steps of:
loading and executing a plurality of speech application tasks in selected ones of multiple processor modules in a speech processing board;
loading in a commonly addressed storage separate from said multiple processor modules selected language models for use by said speech application tasks;
receiving audio data over an audio channel and distributing said audio data to particular ones of said processor modules, wherein said distribution of said audio data to particular ones of said processor modules is determined based upon a speech application tasks executing in said particular ones of said processor modules;
processing said received audio data in said particular ones of said processor modules using said language models selected for use by said speech application tasks; and,
caching in said selected ones of said multiple processor modules portions of said selected language models used by said speech application tasks.

19. The speech processing method of claim 18, further comprising the steps of:
collecting speech task results from said selected ones of said multiple processor modules; and,
forwarding said collected speech task results to a host computer telephony (CT) system over a host communications bus.

20. A machine readable storage having stored thereon a computer program for processing speech, said computer program having a plurality of code sections executable by a machine for causing the machine to perform the steps of:
loading and executing a plurality of speech application tasks in selected ones of multiple processor modules in a speech processing board;
loading in a commonly addressed storage separate from said multiple processor modules selected language models for use by said speech application tasks;
receiving audio data over an audio channel and distributing said audio data to particular ones of said processor modules, wherein said distribution of said audio data to particular ones of said processor modules is determined based upon a speech application tasks executing in said particular ones of said processor modules;
processing said received audio data in said particular ones of said processor modules using said language models selected for use by said speech application tasks; and,
caching in said selected ones of said multiple processor modules portions of said selected language models used by said speech application tasks.

21. The machine readable storage of claim 20, further comprising the steps of:
collecting speech task results from said selected ones of said multiple processor modules; and,
forwarding said collected speech task results to a host computer telephony (CT) system over a host communications bus.
